(19) United States
(12) Patent Application Publication
(10) Pub. No.: US 2003/0123056 A1
(43) Pub. Date: Jul. 3, 2003

(54) Apparatus having precision hyperspectral imaging array with active photonic excitation targeting capabilities and associated methods

(76) Inventors: Donald Michael Barnes, Indialantic, FL (US); Richard Ford, Boca Raton, FL (US)

Correspondence Address: ALLEN, DYER, DOPPELT, MILBRATH & GILCHRIST, 255 South Orange Avenue - Suite 1401, P.O. Box 3791, Orlando, FL, 32802-3791, US

(21) Appl. No.: 10/041,686

(22) Filed: Jan. 7, 2002

Related U.S. Application Data
(60) Provisional application No. 60/260,275, filed on Jan. 8, 2001.

(51) Int. Cl. G01J 3/00

(52) U.S. Cl. 356/300; 356/51; 356/317

(57) ABSTRACT

The Precision Hyperspectral Imaging Array with Active Photonic Excitation Targeting Capabilities (defined as “the instrument”) provides a high performance spectral imaging capability and process for exploiting detailed multispectral, hyperspectral and ultraspectral (defined together within this document as “hyperspectral”) imaging and non-imaging signature information. This is accomplished in real-time and/or near real-time in order to discriminate and identify the unique spectral characteristics of the target within its naturally occurring environment. The instrument contains one or more mechanically integrated hyperspectral sensors installed on a fixed or moveable hardware frame and co-boresighted with a similarly mounted digital camera, calibrated visible light source, calibrated thermal source and calibrated fluorescence source. The array moves across the target via mechanical means, and in doing so, simultaneously carries all necessary passive hyperspectral imaging sensors and active calibration sources to effect collection of absolute radiometrically corrected spectral data against the target at high spatial and spectral resolutions.

### RELATED INVENTION

This invention claims the benefit of provisional application titled, Apparatus Having Precision Hyperspectral Imaging Array With Active Photonic Excitation Targeting Capabilities And Associated Methods, U.S. Serial No. 60/260,275 filed Jan. 8, 2001, which is incorporated herein in its entirety.

### FIELD OF THE INVENTION

The present invention relates generally to a ground based self-contained hyperspectral array for providing and exploiting radiometrically calibrated hyperspectral digital imagery in real-time and near real-time and associated methods. An active excitation source is included with this array, along with calibrated white light and thermal sources to provide natural scene illumination and increase the observed signal-to-noise ratio (SNR) of the target.

### BACKGROUND OF THE INVENTION

Hyperpectral imagers or sensors provide imaging capabilities that combine three distinct photonic technologies: conventional imaging; spectroscopy; and radiometry. This unique combination of technologies enables spectral sensors to produce images that associate a spectral signature with each two-dimensional spatial resolution element (i.e., pixel). The spectral signature is a wavelength value corresponding to the light emitted, reflected, or otherwise associated with an imaged target or its background. In this sense, a spectral sensor produces data elements that can be conceptualized as a 3-dimensional “cube” image. Each cube is formed by taking the spacial plane formed by two perpendicular axes and adding a third axis perpendicular to the spacial plane. On the third axis, is measured the go corresponding spectral values of the underlying imaged target or target's background.

Thus, a hyperspectral image is one that is fully three dimensional in the sense that it can be represented as a high-dimensional vector or matrix. For example, the data cube can be viewed as composed of multiple points each represented by a vector, <X, Y, λ>, where X and Y are spacial values measured, respectively, along the X and Y axes and λ is a spectral value corresponding to the wavelength associated with the target (e.g., emitted or refected). These data cubes are usually constructed sequentially in one of two ways. Either the cube is constructed by sequentially recording one full spatial image after another, each at a different wavelength, or the cube is constructed by sequentially recording one narrow image swath (one pixel in width and multiple pixels long) after another with the corresponding spectral signature for each pixel in the swath.

Hyperspectral imaging has come to play an increasingly important role in remote sensing. Hyperspectral imaging is the use of several dozen to several hundred simultaneously collected image scenes at different incremental frequencies. Typically hyperspectral analysis is accomplished in the form of an image representing a manifestation of the frequencies of reflected or transmitted energy levels within the scene. By manipulating the resulting layers of images (i.e., the data cube), extraction of unique signature information is possible, as well as correlation to established substance spectral libraries and databases. Normally, hyperspectral imaging permits delineation of different classes of vegetative, mineral, and various organic/non-organic targets. Most remote sensing and hyperspectral imaging, however, applies to targets normally located from an airborne platform and at long ranges between target and sensor.

### SUMMARY OF THE INVENTION

With the foregoing in mind, the present invention advantageously provides an apparatus having precision spectral imaging capabilities based on close range imaging of an optimally positioned target. These imaging capabilities are further enhanced by extending the imaging across frequency boundaries using a “virtual” sensor formed of an array of co-boresighted spectral sensors each operating in distinct frequency ranges. These capabilities are complementary but distinct, in that enhanced imaging is achieved as described herein using a spectral sensor at very close range when mounted on a frame for optimally positioning a target. Exclusive of the close range advantage, a further advantage is achieved with a consolidated array of spectral sensors that enables the search and imaging of spectral phenomena occurring across the frequency boundaries of the individual spectral sensors. As described fully herein, the apparatus specifically includes a consolidated array of spectral sensors each of which operates in a distinct spectral frequency and range and which is co-boresighted with the other spectral sensors so as to extend the imaging of a target across several spectral frequency bands. As also described more fully below, the apparatus further includes both a real-time imager(e.g., video or digital camera) co-boresighted with the spectral sensosrs and a target illuminator (e.g., light source for emitting at different preselected frequencies).

The invention advantageously enables previously airborne hyperspectral sensors to be made available for close-in applications in biomedical, security and industrial type applications. The invention further advantageously provides a portable hyperspectral imaging array that can gather data from target areas in their natural environment. The invention also further advantageously includes use of commercial-off-the-shelf (“COTS”)) technologies and the provision to easily upgrade those technologies within the instrument through a modular chassis for holding discrete sensor head components and common data processing resources. The invention yet further advantageously enables the collection of more hyperspectral data by moving the hyperspectral sensors over the target using a motorized drive or moving the target past the sensors.

The apparatus preferably includes a ground mounted frame and along with the plurality of distinct frequency range spectral sensors mounted to the frame. In addition, the light source is mounted to the frame to illuminate the target along with the real-time imager (e.g., a video or digital camera) also mounted to the frame to provide a real time human intuitive perspective of the target. The plurality of spectral sensors, light source, and real-time imager define a consolidated instrument array. The consolidated instrument array is preferably in communication with a controller to coordinate the functioning of the consolidated instrument array. The controller is preferably a single commercial-off-the-shelf (“COTS”)) computer. The controller preferably utilizes industry standard Environment for Visualizing Images (“ENVI”)) software to exploit data under the direction of the operator.

Targets are placed under, alongside, or in front of the array, and may move past the array conveyor belt style, or alternatively, the array may move by means of a motorized drive. Because many hyperspectral sensors are very limited in field-of-view, the ability to move past the target increases the amount of data that can be collected. Also, many airborne hyperspectal sensors operate as “pushbroom”) systems, requiring forward aircraft motion to operate in collecting data along the spectral axis by virtue of their basic mechanical/optical design. The use of these airborne moving sensors over a fixed platform, and moving target mechanisms with pushbroom type systems provides a cost effective conversion to ground operations and permits collection of high resolution spectral data at closer ranges.

To support the vast variety of commercial applications, it is necessary to fully characterize the targets within their ambient environment. These phenomena may occur across a wide frequency range in the electromagnetic spectrum. Conventional hyperspectral sensors are typically limited in collecting to discrete ranges, such as visible/near infrared, short-wave infrared, thermal, etc. But by placing a plurality of spectral sensors, each operating in a distinct frequency range and co-boresighted with each other spectral sensors, the effective spectral coverage can be enhanced beyond the capabilities of each individual discrete sensor. Use of selected combinations of commercially available hyperspectral sensors, respectively operating in the ultraviolet, visible/near-IR, short-wave-infrared, mid-wave infrared and long-wave infrared frequency regions, enables extended coverage of spectral frequency bands as a single virtual array for the instrument.

On a passive sensing basis, the instrument array is used as a high performance calibrated hyperspectral imaging system to observe, collect and analyze naturally occurring spectral absorption and emission phenomenon without interference or invasiveness to the target system. This capability can be further increased by adding active stimulation of the target in those cases where this process will add value to the information base. By analyzing fluorescence, photo-luminescence excitation (“PLE”)) and hyperspectral data together from a consolidated sensor and controlled collection platform, new levels of identifying detail are possible.

By adding active imaging capability in the form of excitation energy, the instrument potential includes not only vast hyperspectral applications, but provides a new level of delineation of target information. By coupling fluorescence to highly detailed hyperspectral data, new levels of detail are extractable from the resulting data cube.

The instrument is operated in combinations of passive and active modes to find and effect the best use of hyperspectral imaging frequencies and algorithms against a given class of target, such as melanomas on human skin, foreign chemical substances on materials and chemicals absorbed into human hair. The various embodiments of the apparatus lead to greater instrument capability to resolve, discriminate and identify target substance compositions for a variety of new applications.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a perspective environmental view of an apparatus including a frame-mounted consolidated instrument array for precision hyperspectral imaging with active photonic excitation targeting and real-time viewing capabilities according to the present invention;

FIG. 2 is a perspective view of a consolidated instrument array for precision hyperspectral imaging with active photonic excitation targeting and real-time viewing capabilities according to the present invention;

FIG. 3 is a schematic block diagram of a controller used to control a precision hyperspectral imaging array with active photonic excitation targeting and real-time viewing capabilities according to the present invention;

FIG. 4 is a perspective view of the display screen of apparatus having a frame-mounted consolidated instrument array for precision hyperspectral imaging with active photonic excitation targeting and real-time viewing capabilities according to the present invention;

FIG. 5 is a schematic flow diagram of an algorithmic-based method of detecting target anomalies based on spectral data according to the present invention;

FIG. 6 is a schematic flow diagram of an algorithmic-based method of matching targets based on spectral data according to the present invention; and

FIG. 7 is a schematic flow diagram of an algorithmic-based method of detecting target changes based on spectral data according to the present invention.

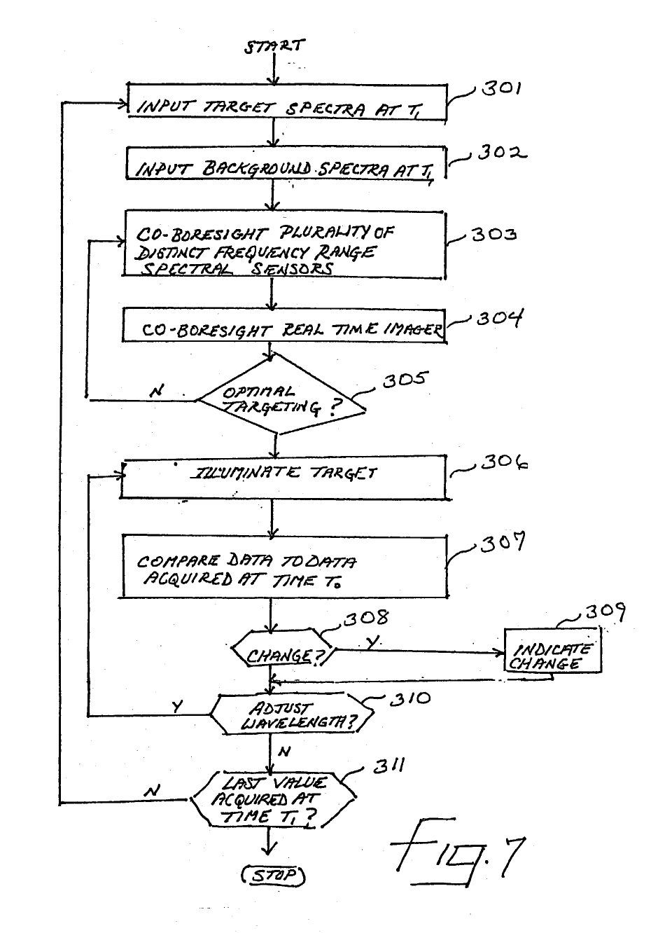

### DETAILED DESCRIPTION OF THE PREFERRED EMBODIMENT

The present invention will now be described more fully hereinafter with reference to the accompanying drawings which illustrate preferred embodiments of the invention. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. The prime notation, if used, indicates similar elements in alternative embodiments.

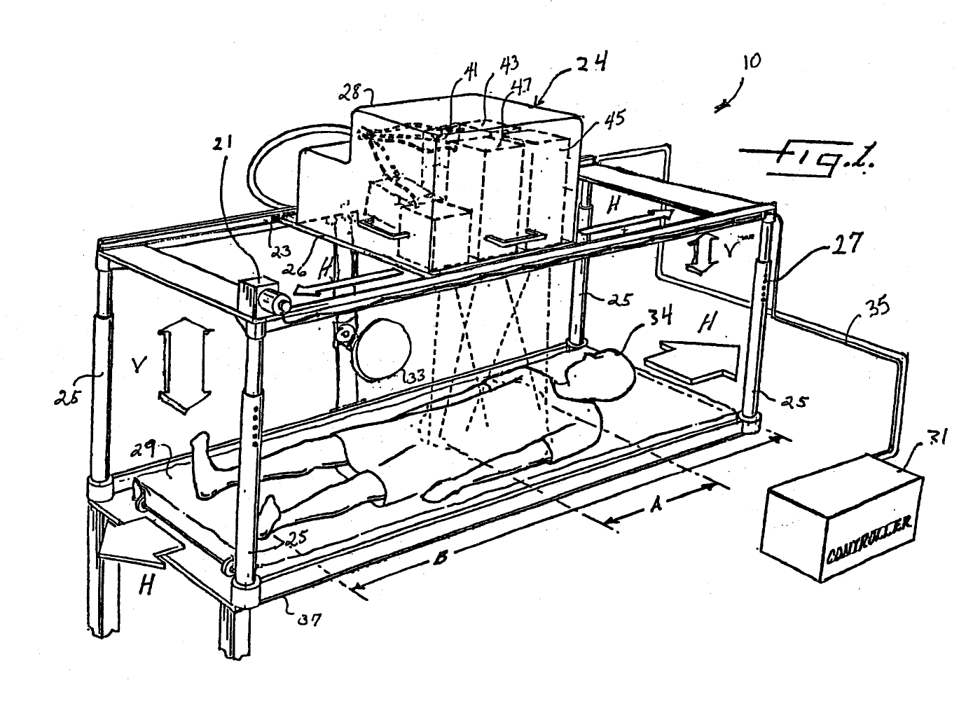

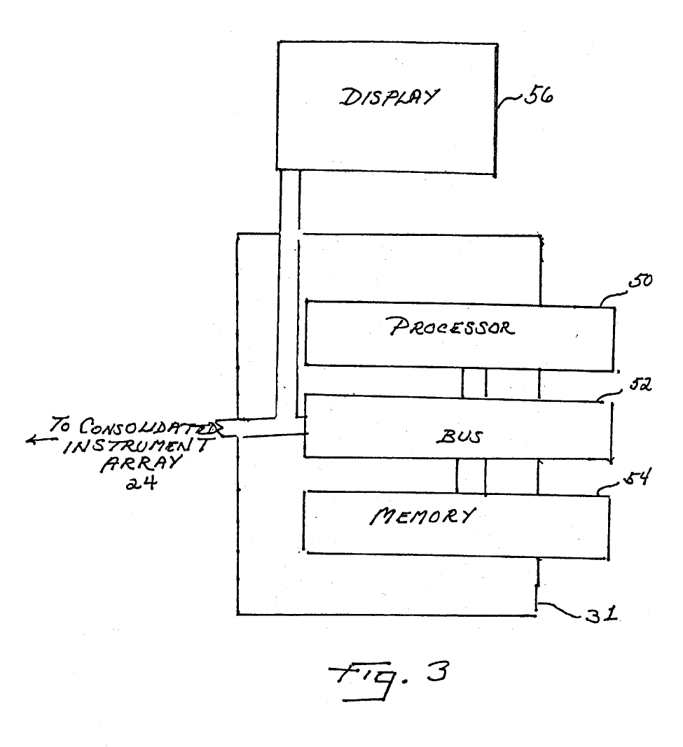

As perhaps best shown in FIG. 1, the apparatus includes a ground mounted frame 27 and preferably includes at least one sensor mounted to the frame to gather data from the target 34, a light source 41 mounted to the frame to illuminate the target 34, and a video or digital camera 49 mounted to the frame to provide a real time human intuitive perspective of the target 34. If the apparatus includes a plurality of sensors, the sensors along with the light source and video or digital camera collectively define a consolidated instrument array 24. The consolidated instrument array 24 is preferably in communication with a controller 31 to coordinate the functioning of the consolidated instrument array 24. As shown in FIG. 3, the controller 31 is preferably a computer including at least one processor 50 and memory 54 for storing instructions and data. The at least one processor 50 and memory 54, moreover, are preferably connected via a bus 52 as will be readily understood by those skilled in the art. The bus 52 also provides a data path between the controller 31 and the consolidated instrument array 24 as illustrated in FIG. 3.

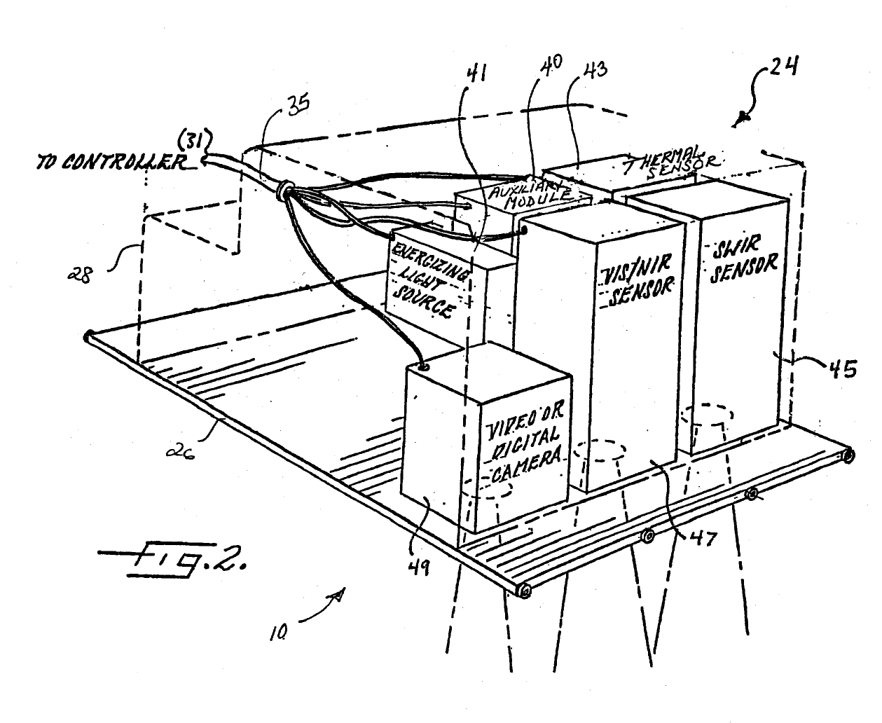

As shown in FIG. 2, the plurality of sensors can range from one through n, with n being a multiple number of discrete sensors. Use of selected combinations of commercially available spectral sensors, respectively operating in the ultraviolet, visible/near-IR, short-wave-infrared, mid-wave infrared and long-wave infrared frequency regions, enables extended coverage of spectral frequency bands as a single “virtual” array for the instrument. This virtual array permits search of spectral phenomenon occurrences which may take place across the boundaries of the individual sensors. The plurality of sensors can be an ultraspectral, multispectral, or hyperspectral array of sensors (hereinafter collectively referred to as “spectral sensors”). These spectral sensors can constitute a variety of different designs such as thermal sensors 43, short wave/infrared sensors 45, or visible/near infrared sensors 47 and may be produced by a variety of vendors.

A further characteristic of the ground mounted frame 27 is modularity and scalability such that a variety of different spectral sensors can be detachably and selectively mounted to the frame 27 so that the frame 27 and consolidated array 24 are still portable. Accordingly, the spectral sensors and the frame 27 are adapted to permit different spectral sensors to be removably positioned on the frame 27. Thus, at different times and in accordance with each particular need, new spectral sensors can be removably positioned on the frame 27, as others not in use or in need of replacement are removed. The ground-mounted frame 27 and frame-mounted sensors also preferably are modular and light enough so as to be deconstructed taken to locations where the material to be scanned is located, and reconstructed there.

Through use of co-bore sighting or sensor alignment techniques in which the center of each sensor points to a common target point, however, the resulting image taken from the spectral sensors will be acquired on an optically consistent basis in any number of hyperspectral band combinations. This common focus permits each spectral sensor reading to be mathematically corrected so that each pixel area from the target 34 for a given spectral sensor may be “matched” with that from any of the other specteral sensors on the array. This capability is the key element in expanding the capability to that of a single “virtual” array operating across many regions of the spectrum from a variety of unmatched and unplanned hyperspectral sensors.

To date, the majority of spectral applications have been in the field of hyperspectral airborne-based imaging. The instrument configuration according to the present invention, however, facilitates conversion to ground operations, opening the door for a vast variety of medical, scientific, and commercial applications at closer ranges. As already noted and described more fully below, the optimal positioning of the target and even a single spectral sensor at close range provides unique advantages and benefits not heretorfore recognized or achieved.

For those sensors that operate as staring arrays (i.e., those which operate from fixed positions rather than moving positions), they may also be included inside the mounting of the instrument array. This design now permits the groundborne merging of two distinctly incompatible types of airborne systems (pushbroom and staring types), further increasing the new applications potential.

As illustrated in FIG. 1, the ground mounted frame 27 for mounting the at least one sensor of a consolidated instrument array 24 can be combined with various devices to expand the target area to be read by the consolidated instrument array 24. In one embodiment, the consolidated instrument array 24 is moved over the stationary target or targets 34 or to the side of the target or targets 34 via a motorized drive assembly mounted to the frame 27. Specifically, the consolidated array 24 is mounted on the frame 27 so that it can be repositioned for optimal imaging. As shown in FIG. 1, the array 24 can be moved over the target 34 using, for example, a drive assembly 21. As expressly illustrated in FIG. 1, the frame preferably includes at least one, and more preferably two, tracks 23 in addition to the drive assembly 21 connected to the frame 27 to reposition at least one of the plurality of spectral sensors by moving at least one spectral sensor along the track 23 to thereby permit the spectral sensors to be optimally positioned relative to the target 34. Thus, as illustrated in FIG. 1, each of the plurality of spectral sensors of the array 24, for example, can be mounted on a movable platform 26 connected to the frame 27 and drive assembly 21 such that the spectral sensors may be moved along the track 23 in at least a substantially horizontal direction H.

To further permit the optimal positioning of the consolidated instrument array 24 relative to a target 34, the frame preferably further has the capability of moving the sensors in a vertical direction V as well. For example, as illustrated in FIG. 1, the frame can include four vertically extendable posts 25 extending vertically from a base 37 of the frame 27. Each of the posts 25 more preferably can be automatically (e.g., hydraulically) or manually adjusted to changed the vertical distance between the consolidated instrument array 24 and the target 34. Preferably, the apparatus 10 further includes a motion encoder or other sensor to sense the presence of the target 34 and position the target 34 and consolidated instrument array 24 relative to one another so as to achieve optimal imaging of the target 34. More preferably, the motion encoder is positioned on the drive assembly 21.

In another embodiment, the target or targets 34 are associated with a motorized drive assembly 21 that includes a conveyor 29 (e.g., endless belt) so as to be moved past the consolidated instrument array 24 in at least a substantially horizontal direction H2. Preferably, as shown in FIG. 1, the conveyor 29 is positioned beneath the platform 26 on which is mounted the consolidated instrument array 24. More preferably a housing 28 overlies the platform 26 to cover the consolidated instrument array 24 seated thereon. In addition, the consolidated instrument array 24 can further include at least one auxiliary module 40 for adding to the sensing capabilities of the consolidated instrument array 24 by adding one or more additional sensors such as an x-ray, fluoroscope, ultrasound, or other sensor.

Thus, the conveyor 29 is able to convey the target 34 to an optimal position relative to the at least one sensor of the consolidated instrument array 24. Again, the apparatus 10 preferably includes a motion encoder or other sensor positioned on the drive assembly 21 to sense the presence of the target 34 and position the target 34 and consolidated instrument array 24 relative to one another so as to achieve optimal imaging of the target 34.

In a third embodiment, the ground mounted frame 27 is equipped with a scan mirror 33 assembly to acquire motion compensated data from targets 34 that are at longer ranges or not feasible to place within the confines of the instrument array. In the preferred embodiment the frame includes the scan mirror and both the movable platform 26 mounted so as to be vertically extendable on the frame 27 along with the base-mounted conveyor 29 to achieve the maximum degrees of freedom for positioning the target 34 and the consolidated instrument array 24 relative to each other.

Although the consolidated instrument array of at least one spectral sensor 24 can be used to collect target data using only naturally occurring light, the light source 41 mounted to the frame can be used to obtain additional or improved data from the target 34. The light source 41 is preferably a tunable, possibly monochromatic, light source which provides the “reservoir” of energy via direct illumination of the target at close range in its natural environment. The target absorbs this energy, then re-emits it at a shifted wavelength. Coupled with the inherent detail of precision hyperspectral imagery (on the order of one half millimeter of spatial resolution at one nanometer spectral resolution in the visible spectrum at a distance of three feet between sensor and target), fluorescence and photoluminescence excitation (“PLE”)) data add additional information to the hyperspectral data cube, in that different wavelengths of a material will result from this excitation. The tunable light source can be set to different frequencies to measure PLE in solids, liquids and gases by taking multiple Hyperspectral data cubes at two or more frequencies and/or amplitudes of illumination, and analyzing both individual images and the difference between image sets in order to extract information about the target 34. The light source 41 can be used for constant scene illumination to greatly increase the target signal as the consolidated instrument array 24 moves over the target 34 or the target 34 moves under the consolidated instrument array 24. This provides a constant spectroradiometric environment in which to calibrate all the data, thus permitting scene characterization simultaneously across the various spectral bands during the collection process.

In the alternative, the light source 41 can be a pulsed illumination to capture hyperspectral data cubes so that luminescence can be gathered from the sample as a function of time. The light source 41 can also be a tunable and fixed frequency fluorescing light source at any frequency to cause fluorescence in solids, liquids, gases, vapors and aerosol targets 34 in order to hyperspectrally measure changes in unique spectral absorption and/or emission return signature data for precision information. Target illumination increases the close-range imaging capabilities provided by the ground-mounted, co-boresighted spectral array.

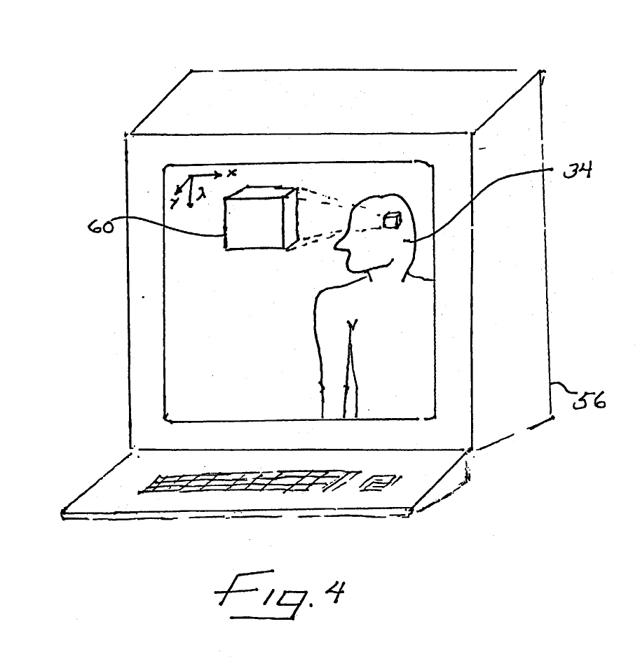

Preferably, the consolidated instrument array 24 further includes a real-time imager 49 mounted to the frame to provide a real time human intuitive perspective of the target 34. As illustrated in FIGS. 3-4, the controller preferably further includes a display 56 that can display a real-time image of the target 34 generated by the real-time imager 49. More preferably, as illustrated in FIG. 4, data cubes 60 generated by the consolidated instrument array 24 can be overlaid with the real-time image of the target 34. This real-time view of the target coupled with the generated spectral data cube allows for increased accuracy in positioning the spectral sensors and target relative to each other.

The apparatus 10 as described enables the enhanced imaging of a target when the target and at least one spectral sensor are positioned relative to each other at close range. Close range is herein understood to be preferably at least one inch (1″) but no more than fifty inches (50″). More preferably, a close range is achieved by positioning the frame-borne target 34 and the frame-mounted at least one spectral sensor relative to one another so that the distance between them is at least six inches (6″) but no more than twenty four inches (24″).

Target data collected from the sensors is transmitted from the moving mount of the array to the controller 31 which as already described includes a computer having at least one processor 50 and memory 54. The data is transmitted via flexible cable, fiber optic, or high bandwidth radio frequency link. It should be noted the hyperspectral data is very large in comparison to conventional color imagery, on the order of one hundred to one thousand times larger for a given scene. It is important that means be established to bring this raw format large volume sensor data from the source of collection to the controller 31 and that the controller 31 having processing and memory storage capabilities as already described. Once the data is stored in memory, it can be processed and manipulated to extract desired trend information. A number of commercially available software packages exist for this purpose, most notably, the Environment for Visual Images (“ENVI”)) program available from Research Systems, Inc. of Boulder, Colo.

Once data has been acquired to develop and utilize appropriate algorithms, the instrument array can be used to then collect and identify unique signatures based on “templates” derived from these processes. These templates include both the unique signature data and the optimal algorithm for exploiting a given signature against a given background. Neural net, heuristic processing methods and artificial intelligence techniques can be used to analyze large scale data trends and extract information from the instrument across the resulting broadband spectral range available from the extended combination of spectral and fluorescence data acquired by the instrument. The computer can be programmed to automate this process for a given degree of certainty and false alarm rate.

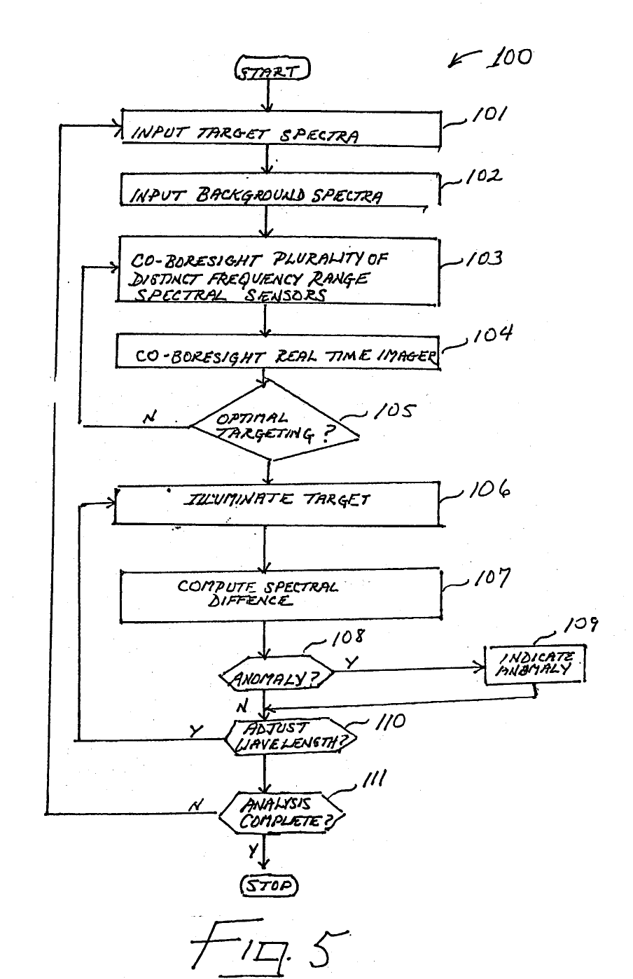

One example of the many algorithmic-based applications enabled by the present invention is a method 100 of using relative spectral differences for anomaly detection as illustrated in FIG. 5. Anomaly detection 100, according to the present invention, preferably includes inputting target spectra data (BLOCK 101) and spectra data associated with the environment or background of the target 34 (BLOCK 102). A plurality of spectral sensors, each preferably operating in a distinct frequency range, is co-boresighted on a target positioned preferably at close range (BLOCK 103). The real-time imager 49 is co-boresighted with the plurality of spectral sensors (BLOCK 104). Preferably, the co-boresighted spectral sensors and real-time imager 49 are then positioned with respect to the target 34 for optimal imaging. If not, further positioning and sighting are undertaken (BLOCK 105). Energy in the form of light provided by the light source 41 is directed at the target 34 to illuminate the target 34 and spectral data is acquired (BLOCK 106). The data so acquired is then compared by the processor 50 to one or more preselected criterion values stored in memory 54 in order to compute a unique spectral difference corresponding to the data element undergoing analysis (BLOCK 107). If the computed difference is anomalous according to a preselected set of criteria (BLOCK 108), then an indication of an anomaly for the particular data element is provided (Block 109). To increase the available data for analysis the target 34 can be imaged by re-setting the wavelength of the light provided by the light source 41 to illuminate the target (BLOCK 110). The steps are repeated until each data element has been analyzed (Block 111).

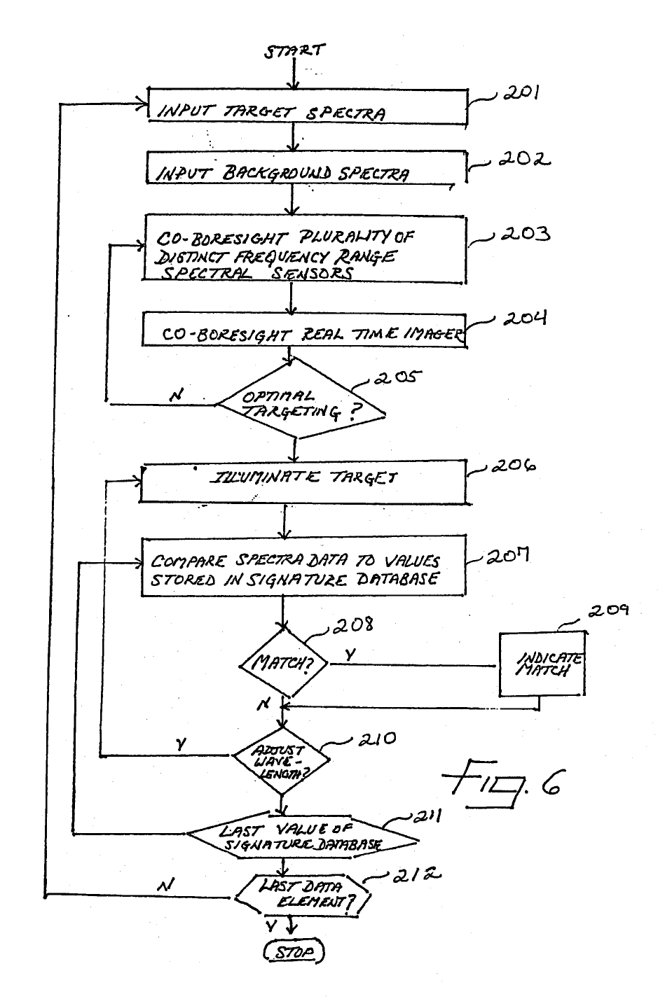

A related application also enabled by the present invention is illustrated in FIG. 6 in which acquired data is compared to that of a database stored in memory 54. Specifically, the application provides a method of spectral matching 200 so as to match a target image from amidst a background with a preselected image or identification criterion. Again, the method 200 is initiated by inputting target spectra (BLOCK 201) and background spectra data (BLOCK 202). Also, again, a plurality of distinct frequency range spectral sensors are co-boresighted with each other (BLOCK 203) and with the real-time imager 49 (BLOCK 204). The target 34, spectral sensors, and real-time imager 49 are positioned relative to one another so as to permit optimal imaging (BLOCK 205)of the target 39 and background. The target is imaged as it is illuminated by light directed to the target from the light source 41 (BLOCK 206). Rather than computing a spectral difference as in the previously illustrated application, however, each acquired data element is sequentially compared to the individual elements of a stored database (BLOCK 207). If a match is made (BLOCK 208) against any one of the stored elements, then a match is so indicated (BLOCK 209). To add to the data available for analysis, the light source can be re-set to provide light at a different wavelength and new data is generated (BLOCK 210). The comparison is repeated until the acquired data element has been compared to each database element (BLOCK 211). The analysis can be performed for multiple data elements acquired by the consolidated instrument array 24 (BLOCK 212).

A specific a use for the application is drawn from the field of criminology in which various physical features of an individual could be compared with those of a database to determine whether the suspect is a wanted fugitive or suspected criminal. Still another use is drawn from the field of medicine in which data is acquired from some target area of a patient's body and compared to stored data representing the characteristics of a healthy person to determine whether the patient's characteristics match that of a health person.

Yet a third application 300 is illustrated in FIG. 6 in which the apparatus 10 is used to determine whether the characteristics at time T₁ of a target have changed since T₀. At time T₁,target and background spectra data provided (BLOCKS 301 and 302). The plurality of distinct frequency band spectral sensors is co-boresighted (BLOCK 303). The real-time imager 49 is co-boresighted (BLOCK 304) and the target 34 is optimally positioned relative to the spectral sensors and real-time imager 49 (BLOCK 305). The target is illuminated with light of a selected wavelength form the light source 41 and the target 34 along with its background is imaged (BLOCK 306) to acquire spectra data at time T₁. Assuming data on the target has been collected at time T₀ and stored in memory 54, each newly acquired data element at time T₁ is compared to corresponding data element acquired at time T₀ (BLOCK 307) to determine whether there has been a change in the characteristics of the target during the time interval T₁-T₀ (BLOCK 308). If there has been a change, the change is so indicated (BLOCK 309). The imaging and comparison can be repeated with the light source illuminating the target with light of a different wavelength (BLOCK 310). The steps are repeated until each of the newly acquired data elements has been compared to a corresponding one (BLOCK 311). This third application also provides tremendous advantages in the field of medicine in which a diseased target area of a patient must be monitored over time to determine changes in the diseased area.

More generally, according to one method aspect of the present invention, enhanced spectral imaging of a target is achieved by positioning the target on a frame 27, mounting at least one spectral senor on the frame 27, and positioning the spectral sensor to provide a substantially close range spectral image of the target 34. As noted already, a substantially close range is defined by the distance between the target and the spectral sensor, and the distance so defined is at least one inch (1″) but no more than fifty inches (50″). More preferably the distance is at least six inches (6″) but no more than 24 inches (24″). The method preferably further includes illuminating the target 34 by directing light onto the target from a light source 41, the light source 41 preferably being capable of being set to different frequencies so as to further enhance imaging of the target by causing the target to re-emit the light at a shifted wavelength.

A further method of enhanced imaging of a target 34 according to the present invention encompasses imaging the target 34 over an extended range of spectral frequency ranges. The method specifically entails positioning a plurality of spectral sensors relative to the target 34, each of the plurality of spectral sensors operating in a different spectral frequency range from the other of the plurality of spectral sensors. Each of the plurality of spectral sensors is co-boresighted so that an imaginary straight line extends from the center of each sensor to a common point on the target. The target receives energy by being illuminated by light directed onto the target from a light source 41 that can be set to different frequencies so as to further enhance imaging of the target 34 by causing the target to re-emit the light at a shifted wavelength. Preferably, the step of illuminating the target 34 specifically includes directing light onto the target 34 so as to cause fluorescence and photoluminescence excitation.

Applications for the for the present invention as an imaging system include a variety of scientific, medical, commercial, and military implementations. In the field of medicine, the present invention in particular provides significant benefits over many conventional devices. Unlike surgery, it is noninvasive. Unlike X-ray, imaging can be accomplished without subjecting a patient to harmful gamma rays. Some of the key areas of application include detection of skin anomalies, such as cancer and melanomas. Others include observation and discrimination of human sub-dermal phenomenon, observation and discrimination of blood oxygen saturation, observation and discrimination of human dermatological phenomena, assessment of the bio-state of burned human tissue and skin, assessment of bio-state of human organs pending imminent transplant into a new recipient, assessment of bio-state of internal organs in vitro (using, for example, hyperspectral endoscopy).

Non medical applications include detection of drug use through skin and hair absorption of substances, discrimination of unique bio-metric parameters, water quality assessment, detection of surface residue from explosives and hazardous materials, polygraphic assessment of human psycho/physiological states through detection of surface changes corresponding to human reactions, gemology assessment, forensic crime scene analysis, counterfeit materials assessment and detection, industrial process control, health state of meats and poultry, materials stress and fractures, and genetic and transgenic materials identification.

The present invention advantageously provides a single, consolidated apparatus utilizing a consolidated instrument array having at least one spectral sensor and preferably including a light source provided light of different preselected wavelength. Preferably, the consolidated instrument array also includes a real-time imager. A complementary, but entirely distinct advantage, is provided by mounting the at least one spectral sensor on a frame that permits the imaging of a preselected target at close range. The at least one spectral sensor provides close range imaging to conduct close-in high spatial/spectral resolution, collection, and analysis. Through collection of large data sample populations and analysis of optimal algorithms, a small portable system will be capable of undertaking these processes on an unattended basis in various field environments. As spectral signatures are collected and developed, the ever increasing quantity of bio-informatics data will expand the scope of applications for the basic design.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims.

That claimed is:

1. A data collection apparatus to collect data necessary to enable joint analysis of fluroescence, photo-luminescence, and hyperspectral data so as to achieve enhanced imaging of a target, the apparatus comprising:
a ground-mounted modular and scalable frame;
a consolidated instrument array connected to the frame, the array including:
a plurality of spectral sensors adapted to be co-boresighted on the target and comprising at least a first spectral sensor operating in a first frequency region and a second spectral sensor operating in a second frequency region distinct from the first sensor's operating region to thereby enable search of spectral phenomenon occurrences that take place across the boundaries of the sensors,
a light source adapted to emit light at different preselected frequencies to illuminate the target, and
a real-time imager positioned to be co-boresighted with the plurality of spectral sensors; and
a controller positioned in communication with the consolidated instrument array to control operation of the consolidated instrument array.

2. An apparatus as defined in claim 1, further comprising at least one track and drive assembly connected to the frame to reposition at least one of the plurality of spectral sensors by moving the at least one sensor along the at least one track to thereby permit the sensor to be optimally positioned relative to the target.

3. An apparatus as defined in claim 1, further comprising a conveyor to convey the target to an optimal position relative to the plurality of spectral sensors.

4. An apparatus as defined in claim 1, further comprising a scan mirror assembly to enable acquisition of motion-compensated data from targets that are not at optimal ranges or alignments relative to the plurality of spectral sensors.

5. A data collection apparatus to collect data necessary to achieve enhanced imaging of a target, the apparatus comprising:
a frame;
a consolidated instrument array connected to the frame, the array including a plurality of spectral sensors adapted to be co-boresighted on the target and comprising least a first spectral sensor operating in a first frequency region and a second spectral sensor operating in a second frequency region to thereby enable a search of spectral phenomenon occurrences that take place across the frequency boundaries of the spectral sensors, and a light source adapted to emit light at different preselected frequencies to illuminate the target; and
a controller positioned in communication with the consolidated instrument array to control operation of the consolidated instrument array.

6. An apparatus as defined in claim 5, further comprising at least one track and drive assembly connected to the frame to reposition at least one of the plurality of spectral sensors by moving the at least one sensor along the at least one track to thereby permit the sensor to be optimally positioned relative to the target.

7. An apparatus as defined in claim 5, further comprising a conveyor to convey the target to an optimal position relative to the plurality of spectral sensors.

8. An apparatus as defined in claim 5, further comprising a scan mirror assembly to enable acquisition of motion-compensated data from targets that are not at optimal ranges or alignments relative to the plurality of spectral sensors.

9. A data collection apparatus to collect data necessary to achieve enhanced imaging of a target, the apparatus comprising:
a frame;
a consolidated instrument array connected to the frame, the array including a plurality of spectral sensors adapted to be co-bore sighted on the target and comprising least a first spectral sensor operating in a first frequency region and a second spectral sensor operating in a second frequency region, and a real-time imager positioned to be co-boresighted with the plurality of spectral sensors; and
a controller positioned in communication with the consolidated instrument array to control operation of the consolidated instrument array.

10. An apparatus as defined in claim 9, further comprising at least one track and drive assembly connected to the frame to reposition at least one of the plurality of spectral sensors by moving the at least one sensor along the at least one track to thereby permit the sensor to be optimally positioned relative to the target.

11. An apparatus as defined in claim 9, further comprising a conveyor to convey the target to an optimal position relative to the plurality of spectral sensors.

12. An apparatus as defined in claim 9, further comprising a scan mirror assembly to enable acquisition of motion-compensated data from targets that are not at optimal ranges or alignments relative to the plurality of spectral sensors.

13. A data collection apparatus to collect data necessary to achieve enhanced imaging of a target, the apparatus comprising:
a consolidated instrument array, the array including:
a plurality of spectral sensors adapted to be co-boresighted on the target and comprising least a first spectral sensor operating in a first frequency region and a second spectral sensor operating in a second frequency region to thereby enable search of spectral phenomenon occurrences that take place across the frequency boundaries of the sensors,
a light source adapted to be emit light at different preselected frequencies to illuminate the target, and
a real-time imager positioned to be co-boresighted with the plurality of spectral sensors; and
a controller positioned in communication with the consolidated instrument array to coordinate functioning of the consolidated instrument array.

14. An apparatus as defined in claim 13, further comprising at least one track and drive assembly connected to the frame to reposition at least one of the plurality of spectral sensors by moving the at least one sensor along the at least one track to thereby permit the sensor to be optimally positioned relative to the target.

15. An apparatus as defined in claim 13, further comprising a conveyor to convey the target to an optimal position relative to the plurality of spectral sensors.

16. An apparatus as defined in claim 13, further comprising a scan mirror assembly to enable acquisition of motion-compensated data from targets that are not at optimal ranges or alignments relative to the plurality of spectral sensors.

17. A data collection apparatus to achieve enhanced imaging of a target, the apparatus comprising:
a ground-mounted frame for optimally positioning the target;
at least one spectral sensor mounted on the ground-mounted frame and operating in a preselected frequency range, the at least one spectral sensor being mounted so as to permit the spectral sensor to image the target at close range; and
a controller positioned in communication with the at least one spectral sensor to control operation of the at least one spectral sensor.

18. An apparatus as defined in claim 17, further comprising a light source adapted to emit light at different preselected frequencies to illuminate the target.

19. An apparatus as defined in claim 18, further comprising a real-time imager positioned to be co-boresighted with the at least one spectral sensor.

20. A consolidated instrument array comprising:
a first spectral sensor operating in a first frequency region; and
at least a second spectral sensor positioned relative to the first spectral sensor so that the at least second spectral sensor is co-boresighted with the first spectral sensor, the at least second spectral sensor operating in a second frequency region distinct from the first sensor's operating region to thereby enable search of spectral phenomenon occurrences that take place across the respective frequency boundaries of the first and at least second spectral sensors.

21. A consolidated instrument array as defined in claim 20, further comprising a light source adapted to emit light at different preselected frequencies to illuminate the target.

22. A consolidated instrument array as defined in claim 20, further comprising a real-time imager positioned to be co-boresighted with the first and at least second spectral sensors.

23. A consolidated instrument array as defined in claim 22, further comprising a display in communication with the real-time imager and the first and at least second spectral sensors to display a real-time image of the target overlaid with at least one spectral data cube corresponding to the target and generated by the first and at least second spectral sensors.

24. A target and consolidated instrument array mounting frame, the frame comprising:
a base having a top surface portion;
a conveyor positioned on the top surface portion of the base and adapted to convey a target positioned thereon in a substantially horizontal direction;
at least two spaced-apart four vertically extendable posts extending upwardly from the base;
at track positioned above the top surface portion of the base and the conveyor, the tack connected to the four vertically extendable posts;
a platform connected to the track and overlying the conveyor, the platform adapted to receive removably receive a plurality of spectral sensors and positioned to move in a substantially horizontal direction so as to allow the plurality of spectral sensors to be co-boresighted and optimally positioned relative to a target positioned on the conveyor; and
a drive assembly connected to the track and platform to propel the platform along the track.

25. A frame as defined in claim 24, wherein the platform is further adapted to removably receive at least one real time imager positioned to be co-boresighted with the plurality of spectral sensors.

26. A frame as defined in claim 25, wherein the frame is further adapted to removably receive at least one light source.

27. A method of enhanced imaging a target over an extended range of spectral frequency ranges, the method comprising:
positioning a plurality of spectral sensors relative to a preselected target to thereby provide an image of the target, each of the plurality of spectral sensors operating in a different spectral frequency range from the other of the plurality of spectral sensors;
co-boresighting each of the plurality of spectral sensors so that an imaginary straight line extends from the center of each sensor to a common point on the target; and
illuminating the target by directing light onto the target from a light source that can be set to different frequencies so as to further enhance imaging of the target by causing the target to re-emit the light at a shifted wavelength.

28. A method as defined in claim 27, wherein illuminating the target comprises directing light on the target so as to cause fluorescence and photoluminescence excitation.

29. A method of enhanced spectral imaging of a target, the method comprising:
positioning the target on a frame;
mounting a spectral senor on the frame; and
positioning the spectral sensor to provide a substantially close range spectral image of the target.

30. A method as described in claim 29, wherein the substantially close range is defined by the distance between the target and the spectral sensor and the distance so defined is at least one inch (1″) but no more than fifty inches (50″).

31. A method as described in claim 30, wherein the distance is at least six inches (6″) but no more than 24 inches (24″).

32. A method as defined in claim 30, further comprising illuminating the target by directing light onto the target from a light source that can be set to different frequencies so as to further enhance imaging of the target by causing the target to re-emit the light at a shifted wavelength.

33. A method as defined in claim 32, wherein illuminating the target comprises directing light on the target so as to cause fluorescence and photoluminescence excitation.
